(19) United States
(12) Patent Application Publication
(10) Pub. No.: US 2006/0218850 A1
(43) Pub. Date: Oct. 5, 2006

(54) No trigger live trap

(76) Inventor: William Ellsworth Thormodson, Hanska, MN (US)

Correspondence Address: WILLIAM THORMODSON, 11511 135 AVE, HANSKA, MN, 56041, US

(21) Appl. No.: 11/394,535

(22) Filed: Mar. 30, 2006

Related U.S. Application Data
(60) Provisional application No. 60/594,342, filed on Mar. 30, 2005.

(51) Int. Cl. A01M 23/20

(52) U.S. Cl. 43/61

(57) ABSTRACT

The objective is to capture raccoons and similar or smaller sized animals without harming them. It improves on current available live traps by having the trap door rest on a single piece of thread, and using this thread as a tripping mechanism, rather than a trap pan and it's related components. When the animal breaks the thread, the door is released. No other live trap uses this method.

### CROSS REFERENCE TO RELATED APPLICATIONS

A provisional patent application, numbered 60/594,342 was filed Mar. 30, 2005.

### STATEMENT REGARDING FEDERALLY SPONSORED RESEARCH OR DEVELOPMENT

Not Applicable

### REFERENCE TO SEQUENCE LISTING A TABLE, OR COMPUTER PROGRAM LISTING COMPACT DISC APPENDIX

Not Applicable

### BACKGROUND OF THE INVENTION

Current live traps use a trap pan of some sort to set them off. Problems associated with a trap pan are setting the proper tension, expensive to manufacture, and malfunction due to bending of pan or related component.

### BRIEF SUMMARY OF INVENTION

The object of the invention is to provide a low-cost, durable live trap, utilizing thread as a tripping mechanism, rather than a trap pan and it's related components. The use of thread or string makes manufacture of the trap very inexpensive. It insures the trap will not malfunction due to bent or broken parts. Because of the size of thread, it also makes catching wary animals more likely.

### BRIEF DESCRIPTION OF SEVERAL VIEWS OF THE DRAWING

FIG. 1E shows the bucket assembly. It can be put together using either screws or bolts. FIG. 1A shows the front bucket with no lid and the bottom cut out. FIGS. 1B and 1C show the middle bucket with center of lid and bottom cut out. FIG. 1D shows the back bucket and the attached lid with the center cut out.

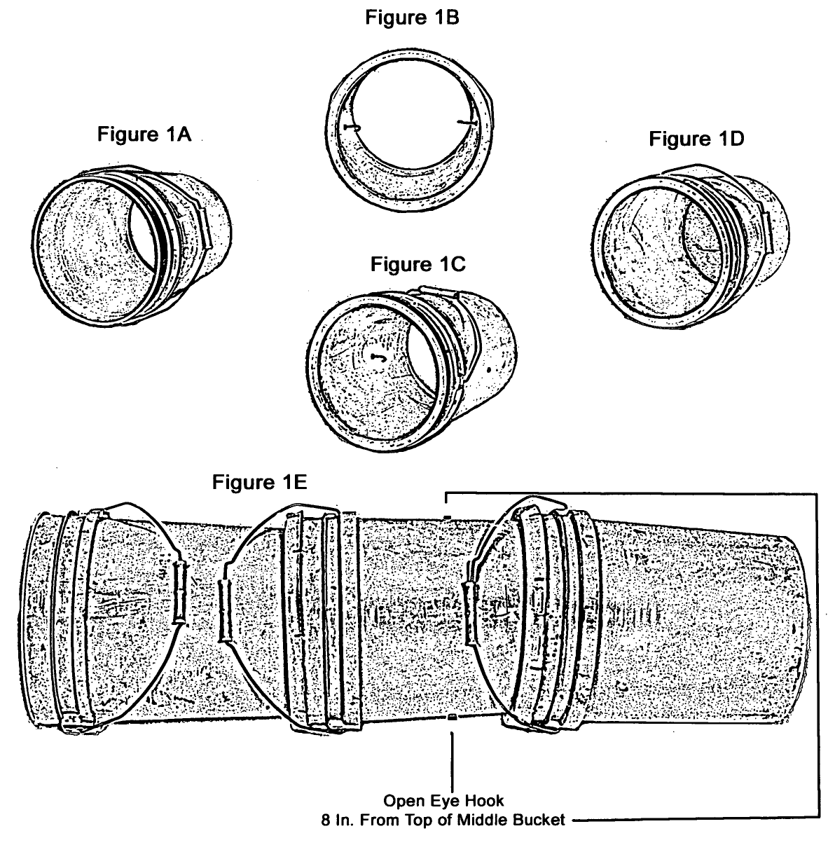

FIG. 2 shows the front assembly. It can be nailed or screwed together.

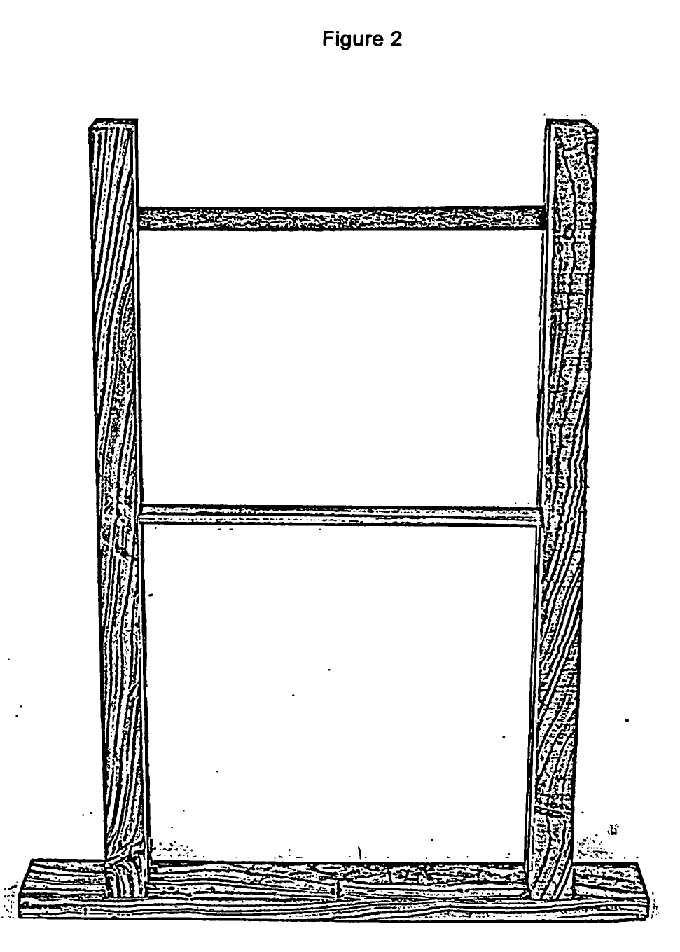

FIG. 3 shows one of the side posts from a different angle, to show where the groove, locking mechanisms and the crosspieces go.

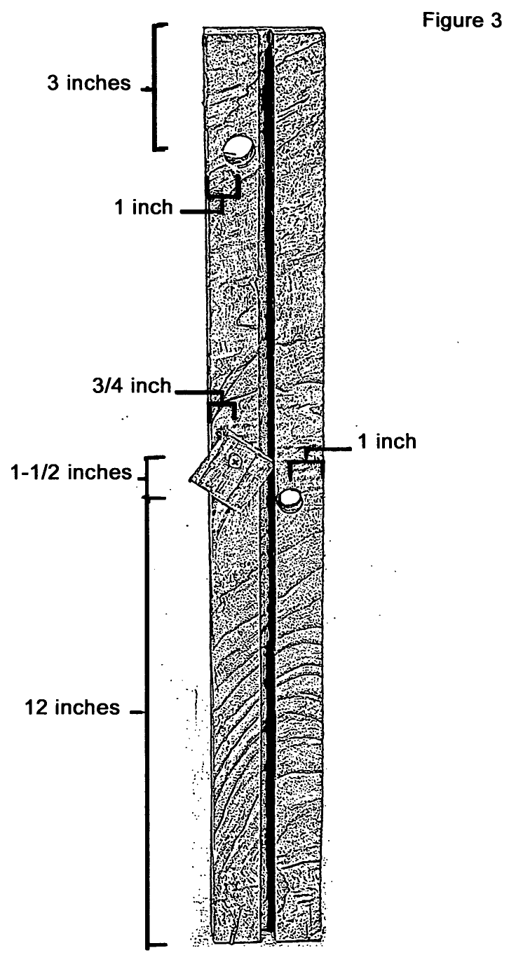

FIG. 4A shows the trap set without the door. FIG. 4B shows the trap set with the door.

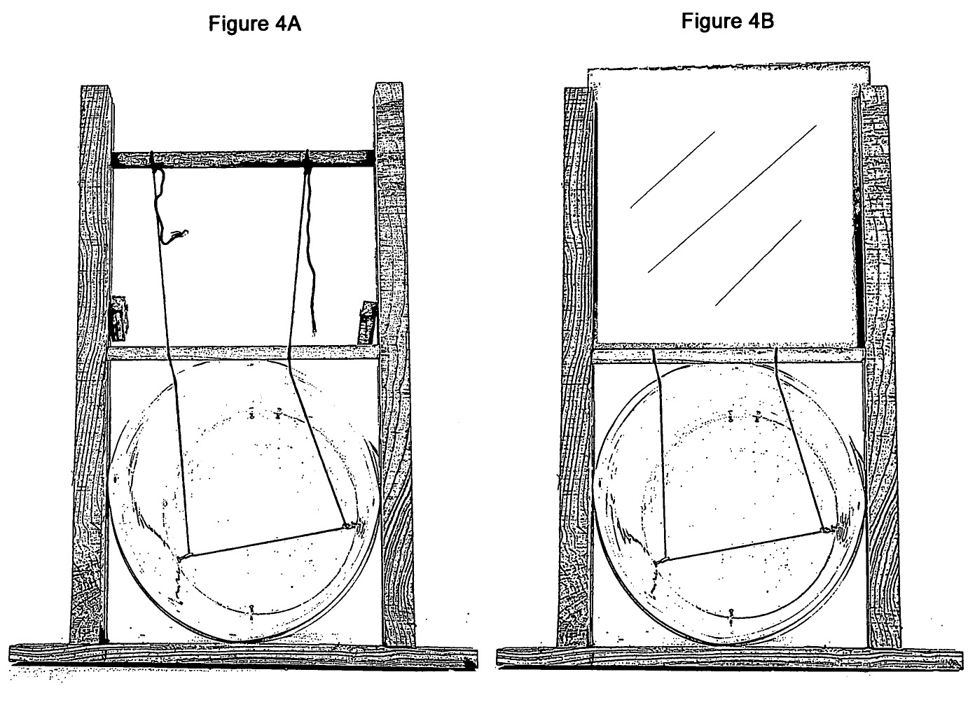

FIG. 5 shows the trap closed and locked with locking mechanisms.

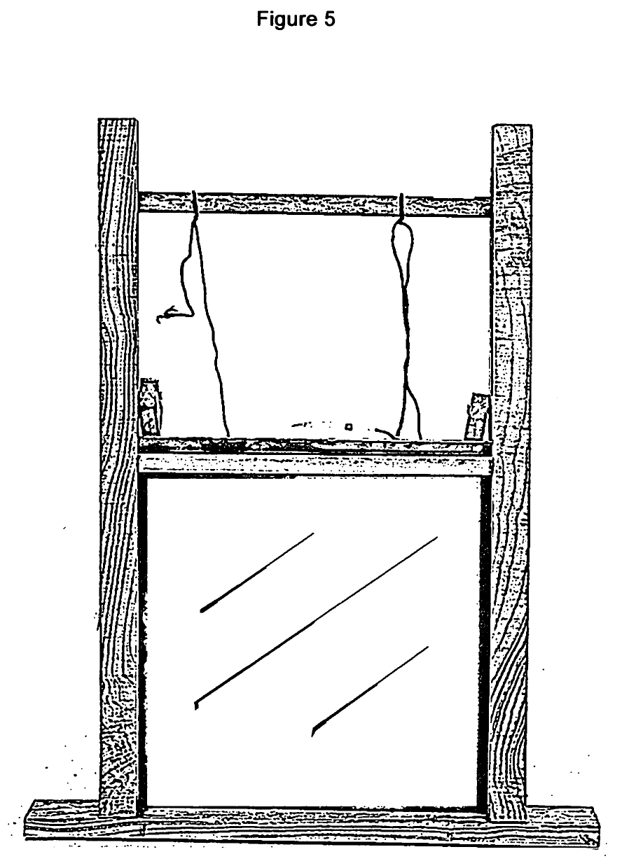

### DETAILED DESCRIPTION OF THE INVENTION

This invention relates to a live trap that enables the user to catch raccoons and smaller sized animals without causing them harm. It's main components include:
1. Bucket assembly: Consists of three ordinary five gallon, plastic buckets, screwed together to form a tunnel
   1 (a): Front bucket has bottom removed. There is no lid.
   1 (b) Middle bucket has the lid attached. The center of lid and in cut out to accommodate the bottom of the front bucket. The bottom is also cut out. There are two open eye hooks, located 8 inches from the top of the bucket opposite one another.
   1 (c): Back bucket has the lid attached. The center of the lid is cut out to accommodate the bottom of the middle bucket.
2. Front Assembly: Has an 11¾ inch opening the size of the top of a plastic five gallon bucket on the bottom formed by two side posts and a base. This is where the bucket assembly attaches. The two sideposts extend above the opening to hold the trap door. Two crosspieces provides stabilization support for the thread which holds the door. There are two locking mechanisms to secure the door when trap is closed.
   2 (a) The base is a wood board 3 inches wide, 1.25 inches thick, and 20 inches long.
   2 (b) and (c): The two side posts are 1.25 inches thick, 3 inches wide. and 24 inches long. There is a groove ⅝ inch deep, and ¼ inch wide running the entire length (24 inches) of, and centered on, each post. The posts are attached to the base, so as to be centered onto the base 2⅞ inches from each end, with the groove facing the inside. The posts should form a “U” with the base. The bucket assembly is inserted into this “U” 1.25 inches and screwed onto the base and two posts.
   2 (d) and (e): Two square blocks, with 1¾ inches sides, and ½ inch thick, are used as locking mechanisms. There is a hole ½ inch from the top and ½ inch from the side in each block. The hole is slightly larger than the screw used to attach them. They are attached one to each post, by a 1.5 inch screw placed 13.5 inches from the bottom of the post, and ¾ inch from the back. The screw is inserted about half way so the blocks swing freely.
   2 (f): A middle crosspiece is attached to each post. The middle crosspiece is a ⅝ inch dowel attached between the two posts. It is to be centered 12 inches from the bottom of the posts and one inch from the front side.
   2 (g): The top crosspiece is a ¾ inch dowel. It is attached to each post and centered three inches from the top of each post and one inch from the back.
   3. Door: A door 13 inches tall, 12⅞ inch wide and ⅛ inch thick fits loosely into the groove on the posts.

The bucket assembly forms a tunnel into which bait is placed to entice the animal. A piece of thread is tied onto one side of the top crosspiece, then into the bucket and threaded through the open eye hooks in a zig zag pattern, then out of the bucket, pulled tight and tied to the other side of the top crosspiece. The door is placed into the groove on the front assembly. It will rest on the thread. When the animal passes into the bucket to get the bait, the thread snaps, releasing the door, and trapping the animal. As the door closes, it slides past the two locking mechanisms. Once past them, the locking mechanisms will prevent the door from opening.

The no trigger live trap can be made using any size or shape container by changing the shape of the opening on the front assembly. It can be formed out of plastic, wood, or metal. Different locking mechanisms can be used. Different types of string, such as fishing line, can be used.

1. A no trigger live trap, whereby a tunnel of three buckets is placed into a front assembly and screwed into place, the side posts on the front assembly have a groove into which a door is placed, the door slides freely up and down this groove, and will rest on a thread that is attached to one side of the top crosspiece, into the bucket through two open eye hooks, and out the bucket to the opposite side of the top crosspiece, pulled tight and tied. When the animal enters the trap, the thread is broken, releasing the door and trapping the animal.
